(19) United States
(12) Patent Application Publication
(10) Pub. No.: US 2010/0050336 A1
(43) Pub. Date: Mar. 4, 2010

(54) SPA CONTROL

(76) Inventor: Shawn Davis, Yucca Valley, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/204,135

(22) Filed: Sep. 4, 2008

(51) Int. Cl. A61H 33/00

(52) U.S. Cl. 4/541.6

(57) ABSTRACT

A spa comprises a water enclosure for holding a quantity of water. The water enclosure has two or more zones. Each of the zones has a plurality of jets. There is a control pad for each of the zones configured to control the water temperature and water pressure coming out of the plurality of jets in each zone.

### BACKGROUND

1. Field

This disclosure relates to spas.

2. General Background

Spas or hot tubs are typically constructed as a molded shell to form a water enclosure with seats, footrests, reclining platforms, and the like molded into a shell. The shell is usually molded from plastic or fiberglass or a composite.

One or more pumps are usually placed under the shell to draw water from the water enclosure and output the water into the enclosure through a variety of nozzles, hydrotherapy jets, and the like. The jets are usually mounted in the shell under the water line, and are designed to provide a comforting or therapeutic effect to a person in the spa. The jets are usually mounted by making a hole in the shell, and fixing the jet in the hole by a use of seals, adhesives, welding compounds, or a combination thereof.

Water supply lines from the pumps to the jets can be flexible tubing or rigid PVC piping. After the jets and tubing are in place, an expandable foaming polymeric material is typically blown into the empty spaces to provide thermal and sound insulation.

### SUMMARY

A spa, in accordance with the present disclosure, comprises a water enclosure for holding a quantity of water. The water enclosure has two or more zones. Each of the zones has a plurality jets. There is a control pad for each of the zones configured to control the water temperature and water pressure coming out of the plurality of jets in each zone.

There is a heating element with a variable wattage capacity and heat sensors in each zone. The heating element enables a voltage, supplied to the heating element, to be adjusted. The temperature sensors monitor the water temperature of each zone. The heating element is adjusted to substantially maintain a user-selected water temperature coming out of the jets in each zone in response to the temperature sensors.

### DRAWINGS

FIG. 1 is a perspective view of a spa in accordance with the present disclosure.

FIG. 2 is a top view of a spa in accordance with the present disclosure.

FIG. 3 is a diagram of a spa in accordance with the present disclosure.

FIG. 4 is a diagram of a spa in accordance with the present disclosure.

While the specification concludes with claims defining the features of the present disclosure that are regarded as novel, it is believed that the present disclosure's teachings will be better understood from a consideration of the following description in conjunction with the drawing figures, in which like reference numerals are carried forward.

### DETAILED DESCRIPTION

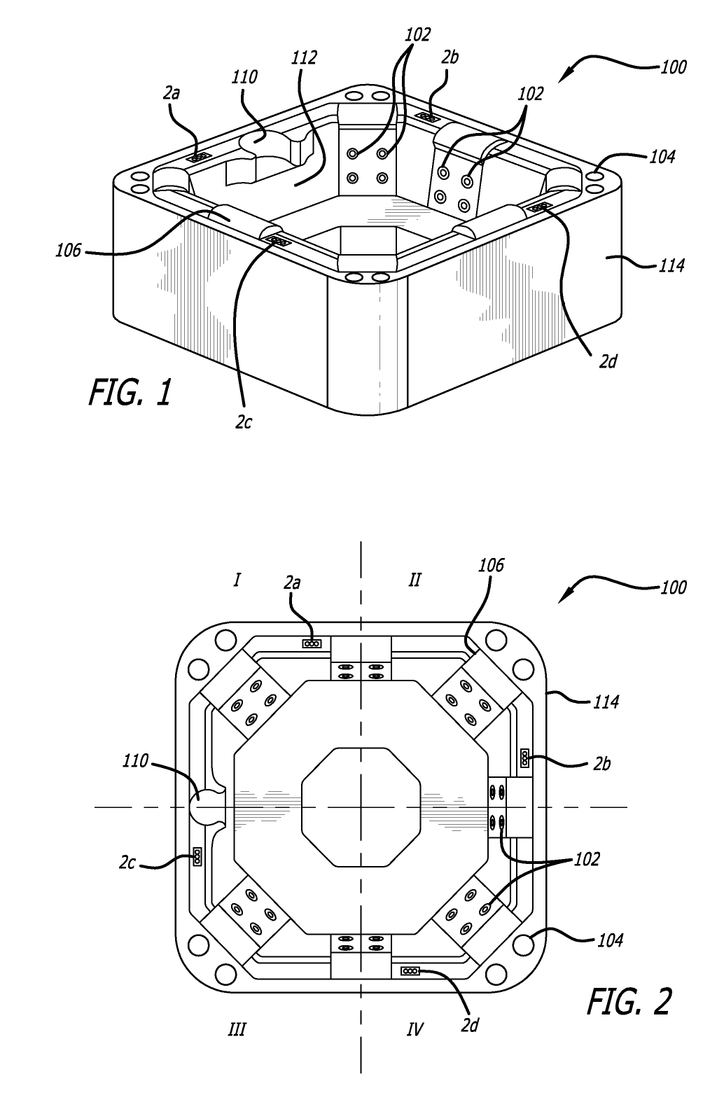

Referring to FIGS. 1-4, a spa 100 in accordance with one embodiment of the present disclosure includes a body 114 for supporting a water enclosure 10. The water enclosure 10 has two or more zones (I, II, III and IV) and the water enclosure 10 holds a quantity of water. There are a plurality of jets 102, there can be cup holders 104, headrests 106 and control pads 2a, 2b, 2c and 2d used to control various functions of the spa 100.

There is a management system or control unit 18 to activate and manage various parameters of the spa 100. The hardware of a typical spa control unit 18 may include a microcomputer for overall control, as well as various relays, switches, discrete logic, fuses, and connection terminals for connecting to line voltage and to line voltage loads, as well as low voltage connections.

Power can be supplied to the spa such as a 120V or 240V single phase 60 cycle, 220V single phase 50 cycle, or any other suitable power sources. A ground can be connected to the control unit 18 and there through to all electrical components which carry power and all metal parts. Electrically connected to the control unit 18 through cable are the control pads 2a, 2b, 2c and 2d. The components powered by the control unit 18 can be connected by cables suitable for carrying appropriate levels of voltage and current to properly operate the spa 100.

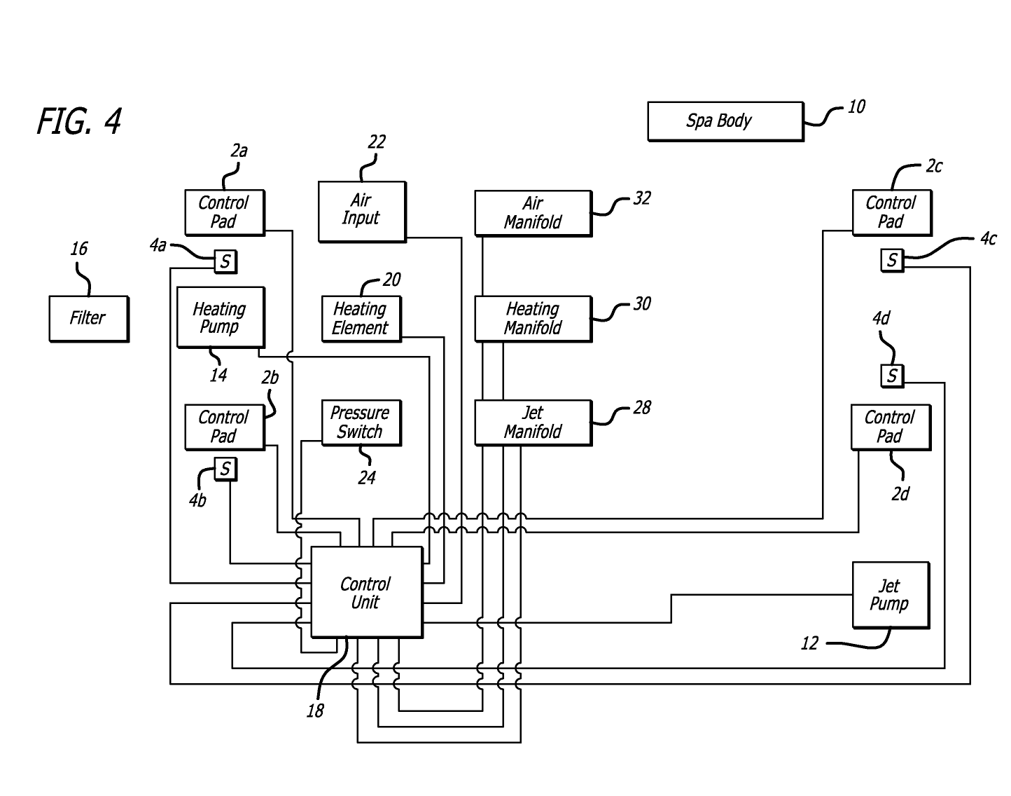

A heating element 20 heats the quantity of water and a filter 16 filters and cleans the quantity of water. The filter 16 can be a cartridge filter of any known filter. The heating element 20 can be an electrical helical heating coil in a cylindrical heater housing. The control unit 18 monitors the temperature of the water flowing through each zone (I, II, III and IV) via sensors 4a, 4b, 4c and 4d and regulates the current applied to the heater coil. The heating element 20 has a variable wattage capability with the functionality to ramp up or down the voltage (240 v. 4,500 watt), thus lowering or raising the overall wattage supplied to the heating element 20. There is an air blower or air input 22. The air input 22 receives air from an air intake 21 and delivers bubbles into the quantity of water prior to output into the water enclosure 10. The heating element 20 and the air input 22 receive and execute instructions from the control unit 18. An electronic relationship is shown in FIG. 4.

A heating pump 14 circulates water through the heating element 20 via piping 40 and a water circulation pump or jet pump 12 that is used to pump water through the plurality of jets 102 when in use. The heating pump 14 can be a low power pump that can be run continuously to circulate the water at a flow rate, such as 5 or 6 gallons per minute (gpm). The jet pump 12 is variable in power output with multiple speeds, frequency controlled, and more powerful than the heating pump 14. The jet pump 12 is for selectively controlling the pressure of water coming out of the plurality of jets 102 in each zone of the two or more zones (I, II, III and IV). The heating pump 14 and the jet pump 12 receive and execute instructions from the control unit 18. The electronic relationship is shown in FIG. 4.

Water is drawn from the water enclosure 10 through a skimmer 110 and suction fitting in the water enclosure 10. The water flows through the heating pump 14, the heating element 20, the water filter 16 and finally flows back into the spa (not shown) through the jets 102 or other low-speed circulation output jets.

The control pads 2a, 2b, 2c and 2d are touch screens situated in an area accessible by a person seated in each of the two or more zones (I, II, III and IV). The control pads 2a, 2b, 2c and 2d control the heating element 20, the air input 22 and power of the jet motor 12 to change the water pressure of the quantity of water separately for each of the zones (I, II, III and IV) within the water enclosure 10. The control pads 2a, 2b, 2c and 2d are in communication with the control unit 18 and instruct the control unit 18 to execute various functions.

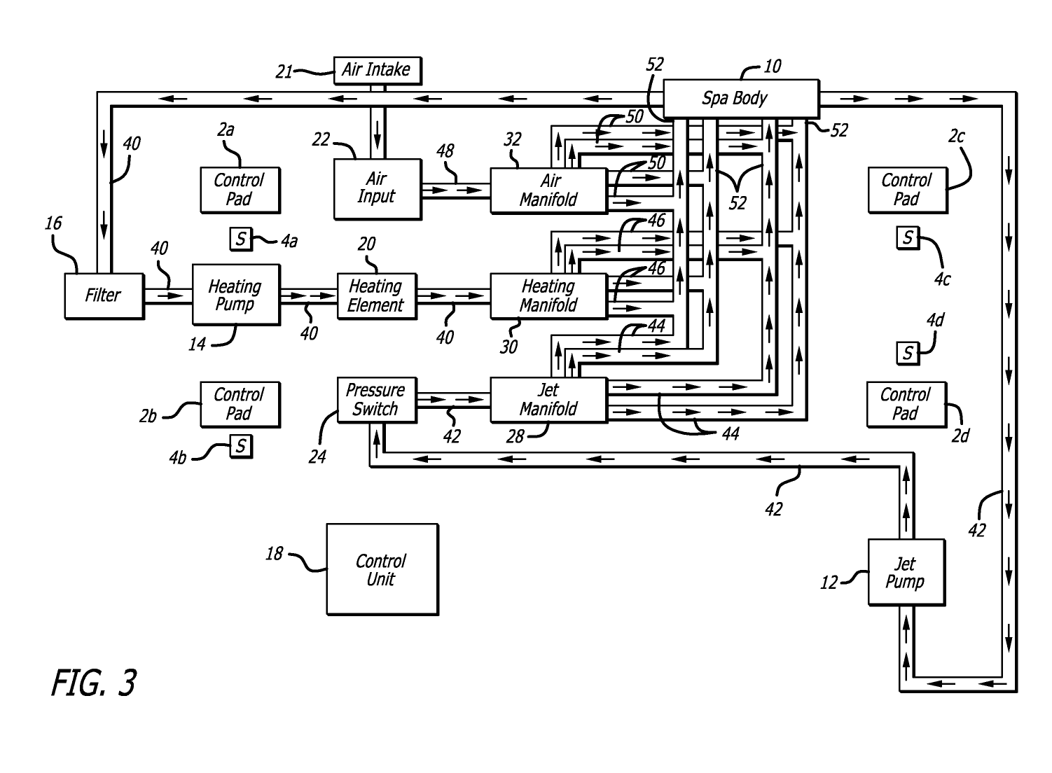

Referring to FIG. 3, there is a heating valve manifold 30 (or heating manifold) through which the heating pump 14 pumps water. The heating valve manifold 30 includes a plurality of valves that can be opened and closed by a signal from the control unit 18. The heating valve manifold 30 has a heating input pipe 40 that directs water from the water enclosure 10 that has been heated by the heating element 20 and filtered by the filter 16 to the heating valve manifold 30. Leading from the heating valve manifold 30, there are at least a number of heating output pipes 46 equal in number to the two or more zones (I, II, III and IV). The output pipes 46 are connected to individual valves of the heating valve manifold 30. In one instance, there could be one pipe 46 for each zone (I, II, III and IV). In such an instance, the pipe 46 may split into two or more pipes to accommodate a number of jets 102 in a particular zone (I, II, III and IV). In another instance, there could be one pipe 46 for each of the jets 102 in the spa 100. The heating valve manifold 30 is in communication with the control unit 18. The control unit 18 can be given instructions through the control pads 2a, 2b, 2c and 2d to adjust the water temperature of the water output by the plurality of jets 102 among the two or more zones by a user selection on the control pads 2a, 2b, 2c and 2d.

Still referring to FIG. 3, there is a jet valve manifold 28 (or jet manifold) through which the jet pump 12 pumps water. The jet valve manifold 28 includes a plurality of valves that can be opened and closed by a signal from the control unit 18. The jet valve manifold 28 is attached to a heating input pipe 42 that directs water from the water enclosure 10 to the jet valve manifold 28. Leading from the jet valve manifold 28, there are at least a number of heating output pipes 44 equal in number to the two or more zones (I, II, III and IV). The output pipes 44 are connected to individual valves of the jet valve manifold 28. In one instance, there could be one pipe 44 for each zone (I, II, III and IV). In such an instance, the pipe 44 may split into two or more pipes to accommodate a number of jets 102 in a particular zone (I, II, III and IV). In another instance, there could be one pipe 44 for each of the jets 102 in the spa 100. The jet valve manifold 28 is in communication with the control unit 18. The control unit 18 can be given instructions through the control pads 2a, 2b, 2c and 2d to adjust the water pressure of the water output by the plurality of jets 102 among the two or more zones by a user selection on the control pads 2a, 2b, 2c and 2d.

Still referring to FIG. 3, there is an air valve manifold 32 (or ambient air manifold) through which the air input 22 delivers bubbles into the spa 100. The air valve manifold 32 includes a plurality of valves that can be opened and closed by a signal from the control unit 18. The air valve manifold 32 is attached to a heating input pipe 48 that directs air to the air valve manifold 32. Leading from the air valve manifold 32, there are at least a number of heating output pipes 50 equal in number to the two or more zones (I, II, III and IV). The output pipes 50 are connected to individual valves of the heating valve manifold 30. In one instance, there could be one pipe 50 for each zone (I, II, III and IV). In such an instance, the pipe 50 may split into two or more pipes to accommodate a number of jets 102 in a particular zone (I, II, III and IV). In another instance, there could be one pipe 50 for each of the jets 102 in the spa 100. The air valve manifold 32 is in communication with the control unit 18. The control unit 18 can be given instructions through the control pads 2a, 2b, 2c and 2d to adjust the concentration of bubbles output by the plurality of jets 102 with the water among the two or more zones by a user selection on the control pads 2a, 2b, 2c and 2d.

In one instance, the heating output pipes 46, jet output pipes 44, and air output pipes 50 of their respective zone (I, II, III and IV), converge prior to outputting the quantity of water out to the water enclosure 10, as shown in FIG. 3. Thus, there would be only one pipe connected to each of the plurality of jets 102. However, many other operable configurations exist while remaining within the scope of the present disclosure. As an example, only the heating output pipes 46 and jet output pipes 44 may converge prior to outputting the quantity of water out to the water enclosure 10 and there could be air bubble outlets throughout the water enclosure 10. In another instance, each of the heating output pipes 46, jet output pipes 44 and air output pipes 50 could have individual means of water output into the water enclosure.

Referring to FIGS. 3-4, a pressure switch 24 monitors pressure of the water going through the jet valve manifold 28. If the pressure switch 24 detects a drop in pressure, a signal is sent from the pressure switch 24 to the control unit 18. The control unit 18 then sends a signal to the jet pump 12 to increase power and pump more water to maintain a user-selected pressure of water coming out of the jets 102. If the pressure switch 24 detects an increase in pressure, a signal is also sent from the pressure switch 24 to the control unit 18. The control unit 18 will then send a signal to the jet pump 12 to decrease power and pump less water to maintain a user-selected pressure of water coming out of the jets 102.

In operation, the spa 100 can be on a timer to filter and heat the spa 100 intermittently or continuously. This intermittent or continuous operation is powered by the heating pump 14. The jet pump 12 can be off. In the event a first user gets into the spa 100 and turns on the jets 102 in their zone (i.e., zone 1), a signal from the first user's control pad (i.e., 2a) will be sent to the control unit 18 to turn on the jet pump 12. If a second user gets into the spa 100 and does not want the jets 102 on in their zone (i.e., zone II), the second user can turn off the jets 102 by using the second user's control pad (i.e., 2b). The second user's control pad (2b) will send a signal to the control unit 18 which will send a signal to the jet valve manifold 28 to close the valve leading to zone II.

In the event the second user decides they would like the jets 102 on in zone 11, the valve for zone II will be opened. This will cause a drop in pressure of the water going to zone I. The pressure switch 24 detects this drop in pressure and sends a signal to the control unit 18 to power up the jet pump 12 to provide more water through the jet valve manifold 28, thus substantially maintaining a consistent water pressure. This operation is the same for n number of users and x number of zones.

In the event that one of the users turns off the jets 102 in their respective zone, the valve controlling water flow to the respective zone (I, II, III and IV) will be closed. Thus, there will be an increase in water pressure to the jet valve manifold 28. The pressure switch will send a signal to power down the motor to substantially maintain a consistent water pressure flowing from the jets 102 in active zones.

There may be an option on the control pad to turn on all the jets and bubbles in the event there is only one person in the spa 100. Such an option would not require a user to individually turn on each zone from each of the control pads 2a, 2b, 2c and 2d.

Preferably, at least one of the pumps has a soft start functionality for prohibiting sudden spikes in current drawn to power the pumps. Electronic devices can consume a large initial current when first turned on (i.e., inrush current). This can cause voltage fluctuations and affect the performance of other circuits connected to a common power supply. To counteract this issue, components can be added in series to throttle back the current initially as the device comes online. Thus, when the pumps come online, they will ramp up slowly to their selected speed.

There is also a temperature sensor (4a, 4b, 4c and 4d) located in each of the two or more zones (I, II, III and IV). The temperature sensors (4a, 4b, 4c and 4d) monitor the water temperature and adjust the power and output of the heating element to substantially maintain a user selected water temperature range coming out of the plurality of jets 102 in each zone (I, II, III and IV).

In operation, a user in the spa 100 may not want the water hotter than the water already is. In such an event, the valve of the heating valve manifold 30 for the user's respective zone (I, II, III and IV) may be shut, such that either no water is coming out of their respective jets or that only water being pumped by the jet pump 12 is coming out of the jets 102 in the user's respective zone (I, II, III and IV).

In the event the user would like to increase the temperature of the water coming out of their respective jets 102, the valve of the heating valve manifold 30 for the user's respective zone would be opened allowing the heated water to mix with water being pumped at a higher speed by the jet pump 12.

In the event a second user gets into the spa 100 and would like to increase the heat in their respective zone (i.e., zone II), the heating element 20 may have to increase power to maintain the desired temperature of both users.

In one instance, when the spa is in use, a user may activate high speed jets, such as jets 102, by activating the high speed jet pump 12, which can be a 1-4 horsepower (0.75-3.0 Kilowatt) water pump that circulates the water through the high speed circulation system or through pipes 42 and 44 at a flow rate greater than 15 gpm (57 Ipm). Suitable pumps are commercially available. When the jet pump 12 is activated, water is drawn in through the skimmer 110 and/or suction fittings at a higher flow rate. The high-speed water exits the jet pump 12, may flow through a one-way valve and flows back into the spa through high speed jets 102.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicant's contribution. The actual scope of the protection sought is intended to be defined in the following claims when viewed in their proper perspective based on the prior art.

1. A spa comprising:
a water enclosure for holding a quantity of water, the water enclosure having two or more zones, each of the two or more zones having a plurality jets;
a control pad for each of the two or more zones configured to control water temperature and water pressure coming out of the plurality of jets in each zone of the two or more zones.

2. The spa of claim 1, further comprising:
a heating element with a variable wattage capacity for enabling a voltage supplied to the heating element to be adjusted for adjusting the overall wattage of the heating element; and
a temperature sensor located in each of the two or more zones, the temperature sensor for monitoring water temperature, wherein the heating element is adjusted to substantially maintain a selected water temperature coming out of the plurality of jets in each zone in response to the temperature sensor.

3. The spa of claim 2, further comprising:
a heating pump for circulating the quantity of water through the heating element and a filter; and
a jet pump, the jet pump has a variable power output that is more powerful than the heating pump for selectively controlling the pressure of water coming out of the plurality of jets in each zone of the two or more zones and wherein at least one of the heating pump and jet pump has a soft start functionality for prohibiting sudden spikes in current draw.

4. The spa of claim 1, wherein the control pad is a touch screen.

5. The spa of claim 3, further comprising a pressure switch, the pressure switch for monitoring water pressure of the plurality of jets, and wherein the power of the jet pump is adjusted to maintain a selected pressure of water coming out of the plurality of jets in each zone in response to the pressure switch.

6. A spa comprising:
a water enclosure for holding a quantity of water, the water enclosure having two or more zones;
a heating element for heating the quantity of water;
a filter for filtering the quantity of water;
a plurality of jets;
a heating pump for circulating the quantity of water through the heating element and the filter;
a jet pump that is variable for selectively controlling the pressure of water coming out of the plurality of jets in each zone of the two or more zones;
a temperature sensor located in each of the two or more zones, the temperature sensor for monitoring water temperature, wherein the heating element is adjusted to substantially maintain a selected water temperature range coming out of the plurality of jets in each zone in response to the temperature sensor; and
a control pad for each of the two or more zones for selectively controlling temperature and water pressure coming out of the plurality of jets in each of the zones of the water enclosure.

7. The spa of claim 6, wherein the jet pump has at least two speeds for controlling the pressure of the quantity of water output from the plurality of jets.

8. The spa of claim 7, wherein the jet pump is more powerful than the heating pump.

9. The spa of claim 6, wherein the heating element has a variable wattage capacity enabling a voltage supplied to the heating element to be adjusted for adjusting the overall wattage of the heating element.

10. The spa of claim 6, wherein at least one of the heating pump and jet pump have a soft start functionality for prohibiting sudden spikes in current drawn to power the at least two pumps.

11. The spa of claim 6, further comprising a pressure switch, the pressure switch for monitoring water pressure coming out of the plurality of jets, and wherein the power of the jet pump is adjusted to maintain a selected pressure of water coming out of the plurality of jets in each zone.

12. The spa of claim 6, wherein the control pad is a touch screen.

13. A spa comprising:
a water enclosure for holding a quantity of water, the water enclosure having two or more zones;
a heating element for heating the quantity of water;
a filter for filtering the quantity of water;
a plurality of jets;
a heating pump for circulating the quantity of water through the heating element and the filter;
a jet pump that is variable and more powerful than the heating pump for selectively controlling the pressure of water coming out of the plurality of jets in each zone of the two or more zones;
an air input, wherein the air input is arranged to deliver bubbles into the quantity of water prior to output to the water enclosure;
a control pad for each of the two or more zones to control the heating element, air input and water pressure of the quantity of water separately for each of the zones;
a heating valve manifold for the heating pump, the heating valve manifold is attached to a heating input pipe and at least a number of heating output pipes equal in number to the two or more zones, wherein the heating valve manifold is controlled by the control pad for selectively adjusting water temperature among the two or more zones;
a jet valve manifold for the jet pump, the jet valve manifold is attached to a jet input pipe and at least a number of jet output pipes equal in number to the two or more zones, wherein the jet valve manifold is controlled by the control pad for selectively adjusting water pressure coming out of the plurality of jets among the two or more zones; and
an air valve manifold for the air input, the air valve manifold includes an air input pipe and at least a number of air output pipes equal in number to the two or more zones, wherein the air valve manifold is controlled by the control pad for selectively adjusting the delivery of bubbles among the two or more zone.

14. The spa of claim 13, wherein the heating element will have a variable wattage capacity enabling a voltage supplied to the heating element to be adjusted for adjusting the overall wattage of the heating element.

15. The spa of claim 13, wherein at least one of the at least two pumps have a soft start functionality for prohibiting sudden spikes in current drawn to power the at least two pumps.

16. The spa of claim 13, wherein the control pad is a touch screen.

17. The spa of claim 13, wherein the heating output pipes, jet output pipes and air output pipes, of their respective zone, converge prior to outputting the quantity of water out to the water enclosure.

18. The spa of claim 13, further comprising a pressure switch, the pressure switch for monitoring the water pressure of the jet valve manifold, wherein the power of the jet pump is adjusted to maintain a selected pressure of water coming out of each jet.

19. The spa of claim 13, further comprising a temperature sensor located in each of the two or more zones, the temperature sensor for monitoring water temperature, wherein the heating element is adjusted to substantially maintain a selected water temperature coming out of the plurality of jets in each zone in response to the temperature sensor.
